(19) United States
(12) Patent Application Publication
(10) Pub. No.: US 2016/0368425 A1
(43) Pub. Date: Dec. 22, 2016

(54) FACIAL TISSUE HOLDER FOR A VEHICLE

(71) Applicant: Martha Kendall, Sparks, NV (US)

(72) Inventor: Martha Kendall, Sparks, NV (US)

(21) Appl. No.: 14/743,134

(22) Filed: Jun. 18, 2015

(51) Int. Cl. B60R 7/04; B65D 83/08

(52) U.S. Cl. CPC B60R 7/04; B65D 83/0805

(57) ABSTRACT

A system for securing a tissue box in a vehicle which includes: a first side of the tissue box; a hook and loop connector adhered to the first side of the tissue box; and a receiving hook and loop connector adhered to an interior surface of the vehicle. In one particular embodiment, the hook and loop connector and/or the receiving hook and loop connector are oval in shape. In an alternative embodiment, the hook and loop connector and/or receiving hook and loop connector are rectangular in shape.

### BACKGROUND OF THE INVENTION

Field of Invention

The present invention relates to a system that securely mounts a box of facial tissue in a vehicle for use by occupants.

Description of Related Art

Facial tissues are a common absorbent disposable paper that is typically used to wipe mucous or other body fluids from the nose of the user. Further facial tissues are used for other items such as drying tears from eyes, wiping debris from around the mouth or simply wiping hands or fingertips of other debris or body fluids. The facial tissue is usually dispensed through a box that is normally sold through a retail source. Facial tissues are placed within the box and are interlinked out in order to allow the accessibility of the facial tissues during use. A user typically removes the facial tissue from a slit provided in the top of the box and another tissue appears in a ready position for removal by the user. This sequence continues until the entire amount of facial tissue within the box is consumed.

Facial tissues are great in a stationary environment and are typically placed in bathrooms, on a desk or at other convenient positions for ready accessible use. However the tissue box is also convenient for drivers of vehicles. Many times a driver may sneeze or may require the use of a facial tissue and it would be therefore convenient to have a tissue box nearby that could be easily used by the driver or other occupant of the vehicle. Typically, tissue boxes are small in size and therefore are easily tossed about a vehicle due to the movement and inertia caused by the vehicle. Therefore it would be advantageous to have a system that securely mounts a tissue box within a vehicle so that the tissues are easily assessable to the occupants. In particular, one prior patent discloses a tissue dispensing apparatus in U.S. Pat. No. 6,561,378 to Roessler. The tissue container of Roessler includes a lower surface, which is placed upon a non-skid friction enhancement device. The tissue container is therefore removable affixed to the adhesive surface and resists movement when placed in a vehicle. Further alternatives are necessary for the consumer use and as such will be revealed with the present invention.

### SUMMARY OF THE INVENTION

The present invention relates to a system for securing a tissue box in a vehicle which includes: a first side of the tissue box; a hook and loop connector adhered to the first side of the tissue box; and a receiving hook and loop connector adhered to an interior surface of the vehicle. In one particular embodiment, the hook and loop connector and/or the receiving hook and loop connector are oval in shape. In an alternative embodiment, the hook and loop connector and/or receiving hook and loop connector are rectangular in shape.

### BRIEF DESCRIPTION OF DRAWINGS

FIG. 1 depicts a first embodiment of a system used to secure a tissue box in a vehicle.

FIG. 2 depicts a second embodiment of the system used to secure a tissue box in a vehicle.

### DETAILED DESCRIPTION

The present invention relates to a system that is used to secure a box of tissue within a surface of a vehicle. The system secures the tissue box through the use of hook and loop connectors. A hook and loop connector is placed on an interior surface of the vehicle and a reciprocal hook and loop connector is placed on one side of the tissue box. The hook and loop connectors provide a means to adhere the tissue box onto the interior surface of the vehicle. Tissue is then dispensed through an opening of the tissue box and therefore allows for the user to conveniently access tissue once secured within the vehicle. The receiving hook and loop connector is placed in a convenient position within the vehicle as the tissue box is simply adhered to the hook and loop connector provided.

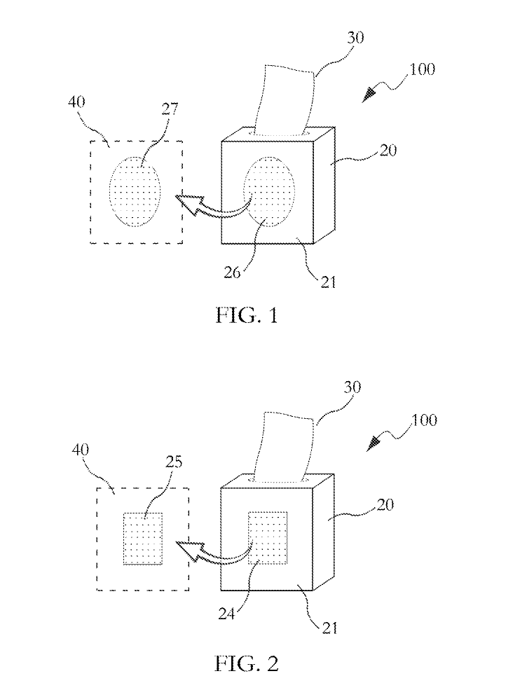

In reference to FIG. 1, a first embodiment of a system for securing a tissue box onto a vehicle surface is depicted. A facial tissue holder 100 includes a Tissue Box 20 that dispenses Tissues 30. On one side or a first Side 21 of the Tissue Box 20 a Hook and Loop Connector 26 is provided in the first embodiment. This Hook and Loop Connector 26 adheres to a receiving Hook and Loop Connector 27 shown on a Surface 40 of the vehicle. In this particular embodiment the hook and loop connectors are oval shaped surfaces that are securely attached first to the surface 40 of the vehicle and onto a Side 21 of Tissue Box 20.

In reference to FIG. 2, a second embodiment of the system for securing a tissue box, a Hook and Loop Connector 24 is placed on a first side of Tissue Box 20 and adheres to a receiving Hook and Loop Connector 25 placed on vehicle Surface 40 shown as a second alternative to the present invention. The Hook and Loop Connector 24 and receiving Hook and Loop Connector 25 are rectangular in shape in the second embodiment. During use a user affixes the Hook and Loop Connecting Receiver 27 or 25 to the vehicle surface and then adheres a reciprocal hook and loop connector onto the Tissue Box 20. The system therefore secures the tissue box 20 in a fixed position to allow for the user to access tissues dispensed through Box 20. Once the tissue box is empty a new box may be conveniently adhered to the receiving hook and loop connector provided on the interior surface of the vehicle. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for securing a tissue box in a vehicle comprising:
a. a first side of the tissue box;
b. a hook and loop connector adhered to the first side of the tissue box; and
c. a receiving hook and loop connector adhered to an interior surface of the vehicle.

2. The system for securing a tissue box according to claim 1, where the hook and loop connector is oval in shape.

3. The system for securing a tissue box according to claim 1, where the receiving hook and loop connector is oval in shape.

4. The system for securing a tissue box according to claim 1, where the hook and loop connector is rectangular in shape.

5. The system for securing a tissue box according to claim 1, where the receiving hook and loop connector is rectangular in shape.
